(19) United States
(12) Patent Application Publication
(10) Pub. No.: US 2013/0171738 A1
(43) Pub. Date: Jul. 4, 2013

(54) Hydrophobicity Modulating Underwater Chemical Sensor

(71) Applicants: Hyungryul Johnny Choi, Cambridge, MA (US); Ayse Asatekin Alexiou, Somerville, MA (US); Se Young Yang, Cambridge, MA (US); Christy D. Petruczok, Cambridge, MA (US); Karen K. Gleason, Cambridge, MA (US); Nicholas M. Patrikalakis, Cambridge, MA (US); George Barbastathis, Boston, MA (US)

(72) Inventors: Hyungryul Johnny Choi, Cambridge, MA (US); Ayse Asatekin Alexiou, Somerville, MA (US); Se Young Yang, Cambridge, MA (US); Christy D. Petruczok, Cambridge, MA (US); Karen K. Gleason, Cambridge, MA (US); Nicholas M. Patrikalakis, Cambridge, MA (US); George Barbastathis, Boston, MA (US)

(73) Assignee: MASSACHUSETTS INSTITUTE OF TECHNOLOGY, Cambridge, MA (US)

(21) Appl. No.: 13/704,934

(22) PCT Filed: Jun. 17, 2011
(86) PCT No.: PCT/US11/40909

§ 371 Date: Feb. 27, 2013

Related U.S. Application Data
(60) Provisional application No. 61/356,125, filed on Jun. 18, 2010.

(51) Int. Cl. G01N 27/06

(52) U.S. Cl. CPC G01N 27/06
USPC 436/150; 422/82.02

(57) ABSTRACT

A chemical sensor that works while being submerged in a highly conductive medium is described. The chemical sensor includes hydrophobic structures that are distributed on conductive electrodes and are separated by small air cavities while submerged in the conductive medium. The hydrophobic structures are arranged such that their hydrophobicity varies in response to exposure to a target analyte. The change in the level of hydrophobicity results in permeation of the conductive liquid on to the conductive electrodes, thereby reducing the resistance levels between the conductive electrodes. The sensor indicates presence of the target analyte in response to detection of a change in resistance between at least two of the conductive electrodes.

### RELATED APPLICATIONS

This application claims the benefit of U.S. Provisional Application No. 61/356,125, filed on Jun. 18, 2010. The entire teachings of the above application are incorporated herein by reference.

### BACKGROUND

Chemical detection of underwater contaminants, explosives, and organic species plays an important rule in various applications. Specifically, effective contaminant detection in water is critical in protecting drinking water assets from intentional and natural contamination [1]. Further, monitoring the presence of explosives in the environment is an important homeland security concern [2]. Also, detection of underwater organic species assists in tracing buildups of bio-film layers, which is one the most common forms of surface contamination (often referred to as “biofouling”) in engineered water systems [3].

A number of different detection methods have been applied in chemical sensing devices. For example, biosensors [4,5], electrochemical [6] and fiber optic [7] sensors, as well as devices utilizing chromatography [8], spectrophotometry [9], and Raman spectrometry methods [10] have been used. However, sensors that use the aforementioned techniques typically require complicated sensing and readout components. Moreover, such sensors are comparatively large in size and, as such, consume significant amounts of power during operation.

### SUMMARY

Certain embodiments of the present invention relate to a chemical detection sensor that includes a plurality of hydrophobic structures spatially distributed on conductive electrodes. The plurality of hydrophobic structures are separated by short gaps and are arranged to have a hydrophobicity that varies in response to exposure to a target analyte while submerged in a conductive liquid medium. The sensor further includes an indicator that indicates detection of the target analyte in response to detection of a change in resistance between at least two of the conductive electrodes.

The conductive liquid medium may be water.

The hydrophobic structures may be at least one of microstructures or nanostructures. The structures may be in an array of symmetric or non-symmetric structures. The hydrophobic structures, upon being submerged in the conductive liquid medium, may create high contact angles with the conductive liquid that result in forming air gaps between the conductive electrodes and surrounding conductive liquid.

The conductive electrodes may be electrically disconnected from one another. By arranging the conductive electrodes electrically disconnected from one another, embodiments of the present invention ensure that there is an initial high resistance between the electrodes. As such, the electrodes are initially separated by an air gap and are electrically disconnected. This air gap may cause an initial high (e.g., infinite) resistance between the conductive electrodes.

The sensor may include a display that signals off and on states of the sensor. In certain embodiments, when the electrodes are only separated by corresponding air gap and are electrically disconnected, the sensor may display/indicate an off state.

The hydrophobicity of the structures may decrease in response to exposure to the target analyte. The exposure to the target analyte includes at least one of reaction to the target analyte or absorption of the target analyte. The decrease in the hydrophobicity of the structures may allow permeation of the conductive liquid on to the conductive electrodes. The permeation of the conductive liquid on to the conductive electrodes may result in reduction of the resistance between at least two of the conductive electrodes.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a schematic design of a sensor according to embodiments of the present invention.

FIG. 1B is an illustration of an example of structures that may be used with embodiments of the present invention.

FIG. 2 is a side view of a sensor prior to detection of target molecules.

FIG. 3 is a side view of the chemical sensor 100 after detection of target molecules.

FIG. 4 is an illustration of an example embodiment of the present invention.

### DETAILED DESCRIPTION

A description of example embodiments of the invention follows.

Embodiments of the present invention allow detection of chemicals with low concentrations in conducting liquid medium (e.g., sea water and natural water). Embodiments of the invention may be adapted to various applications that monitor biofouling, explosive concentrations, and contaminants in water. Such applications may be crucial for security and hygiene. Moreover, if a sensor developed according to the embodiments of the invention is placed on an Autonomous Underwater Vehicle (AUV), it can work as a water quality monitoring station to improve the tracking of water pollution sources. Such a sensor may also be used to detect water in an oil tank by adapting the appropriate material and dimensions for the micro/nano structures [11].

Certain embodiments of the present invention relate to a small, inexpensive, low-power chemical sensor that detects target molecules in a liquid environment. Specifically, a sensor according to certain embodiments may detect target molecules upon being submerged in water by utilizing changes in hydrophobicity upon exposure to the target molecules.

The terms “target molecule” or “target analyte,” as used herein, are broad terms that are used in their ordinary sense, including, without limitation, to refer to a substance or chemical constituent in a fluid. Examples of the target molecule or target analyte include, but are not limited to, biological fluids (e.g., blood, interstitial fluid, cerebral spinal fluid, lymph fluid, or urine), naturally occurring substances, artificial substances, metabolites, reaction products, glucose, lactate, salts, sugars, proteins fats, vitamins and hormones naturally occurring in blood and/or interstitial fluids. The target molecule/analyte may be naturally present in the biological fluid (e.g., a metabolic product, a hormone, an antigen, an antibody, etc.) or may be introduced into the body (e.g., a contrast agent for imaging, a radioisotope, a chemical agent, a fluorocarbon-based synthetic blood, or a drug or pharmaceutical composition). In some embodiments, the target molecule/analyte may include metabolic products of drugs and pharmaceutical compositions. Further, in certain embodiments, the target molecule/analyte may include under water contaminants, organic species, and/or explosives.

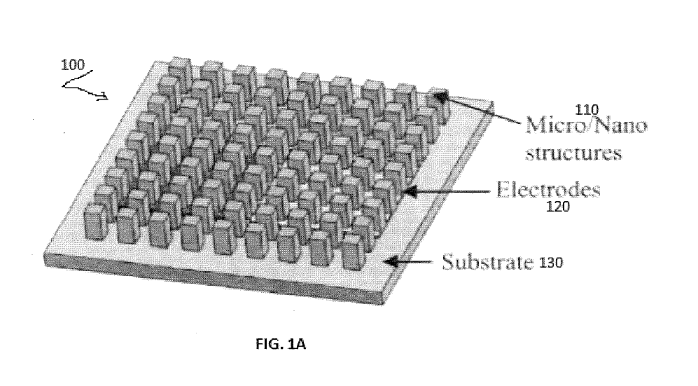

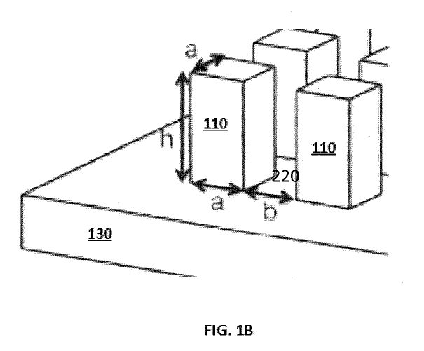

FIG. 1A is a schematic design of a sensor 100 according to certain embodiments. The sensor 100 includes a substrate 130 and a plurality of structures 110.

The term “substrate,” as used herein, is a broad term that is used in its ordinary sense, including, without limitation, to refer to a covering that is applied to a material on which a process is conducted. Examples of the substrate include, but are not limited to, gold, silver silicon, platinum, or aluminum substrates. Further, in some embodiments, the substrate may include a metal and/or a ceramic and/or a polymeric substrate. Alternative substrate materials include, for example, stainless steel and plastic materials such as delrin, etc. In some embodiments, the substrate may be non-rigid and/or may include a layer of film or insulation that is used as a substrate, for example plastics such as polyimide and the like.

The term “structures,” as used herein, is a broad term that is used in its ordinary sense, including, without limitation, to refer to materials that exhibit strength and/or electrical/thermal properties that may utilized by embodiments of the present invention. The structures 110 may be microstructures or nanostructures. In certain embodiments, the structures may be formed on material substrates having particular material properties (e.g., electrical properties of materials such as gold, silver, platinum silicon, aluminum, etc.). Carbon nanotubes are one type of the nanostructures that may be used with embodiments of the invention. The carbon nanotubes may be single-walled or multi-walled carbon nanotubes. In some embodiments, structures such as nano-horns, nano-coils, nano-beads, etc. may be used. Other structures, such as metal-containing nanotubes, peapod nanotubes containing fullerene or metal-containing fullerene, and other carbon nanotubes containing any substance, may also be used with some embodiments of the invention. In some embodiments, the structures may include inorganic nanotubes, such as Tungsten disulfide, Boron nitride, Silicon, Titanium dioxide, molybdenum disulfide, bismuth, and/or copper.

The structures 110 are distributed onto conductive electrodes 120. In some embodiments, the electrodes may be electrically disconnected from one another. The structures 110 are made out of hydrophobic materials.

The term “hydrophobic” refers to a physical property of the structures 110 that causes the structures 110 to be repelled from a mass of water. Hydrophobic materials/molecules are often non-polar and, as such, upon being submerged in water, tend to cluster together and form micelles. Examples of such materials include, but are not limited to, silicone, silanes (e.g., alkylsilanes, fluoroalkylsilanes), alkanes, oils, fats, and fluorocarbons. Preferred materials that can switch between hydrophobic and hydrophilic states include poly (N-isopropylacrylamide) modified surfaces (PNIPAAm) [12].

The structure 110 can be of any shape (e.g., hexahedron, cylinder, tetrahedron, mesh, etc.), as long as their geometrical structure can allow for creation of short distances (i.e., air gaps) between the structures. The distribution of the structures includes any symmetric or non-symmetric array that would preserve the distances (air gaps) mentioned above. Embodiments of the present invention may utilize any number of structures. For example, sensors having two or more structures may be used.

FIG. 1B is an illustration of an example of structures that may be used with embodiments of the present invention. For example, as shown in FIG. 1B, the structures may be micro or nanopillars that are arranged in rectangular row and column configurations on a substrate 130. The geometrical dimensions, h, a, and b, denote the height, length, and distance between two pillars, respectively. The geometrical dimensions may be of any values that can preserve an air gap 220 between the structures. Various values for the geometrical dimensions may be employed. For example, in one embodiment, h=1 micrometer, a=100 nanometer, and b=100 nanometer. In certain other embodiments, h=50 micrometer, a=20 nanometer, and b=20 nanometer.

Conductive liquid mediums (such as water) exhibit high contact angles on hydrophobic surfaces. Accordingly, the structures 110 are arranged such that, once submerged in a conductive liquid medium, the combined effect of their geometrical structures and their low surface energy creates a highly hydrophobic surface that has a large contact angle. The high contact angle between the conductive liquid and the material that the structures 110 are made of, as well as the very short distances between the structures 110, forms an air gap 220 between surrounding water and the electrodes.

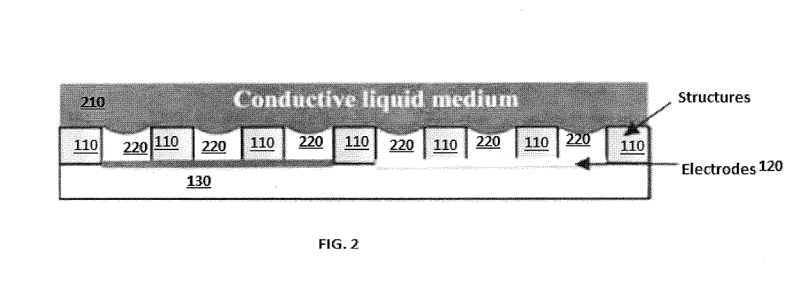

In certain embodiments, the sensor 100 includes micro and/or nanostructures 110 and two conductive electrodes 120. As described above, the micro/nanostructures 110 are positioned on top of the electrodes 120 and are composed of a hydrophobic polymeric material. The combination of the dimensions and geometric shape of these structures 110 and the chemical properties of the material from which the structures 110 are manufactured result in a very high contact angle. The high contact angle leads to the retention of water on top of the micro/nanostructures, resulting in an air gap 220 (shown in FIG. 2).

FIG. 2 is a side view of the chemical sensor 100 prior to detection of target molecules. As shown in FIG. 2, once submerged in a conductive liquid medium 210 (e.g., water), the geometrical configuration of the structures 110, positioned on the substrate 130, along with the very small distances between them form an air gap 220 between surrounding water 210 and the electrodes 120. This preserves an initial high resistance between the electrodes 120, although the sensor is submerged into a conductive liquid medium 210 (e.g., tap water or sea water). This initial high resistance causes the sensor to output an “OFF” signal as its readout.

The structures 110 are made out of a material that reacts to target chemicals and/or absorbs the target chemicals and gradually becomes less hydrophobic. Accordingly, the micro/nanostructures 110, upon adsorption or reaction of the target chemicals, become relatively more hydrophilic as the sensor encounters the target chemical. This results in the permeation of water on to the electrodes 120, which in turn leads to conduction of current from one electrode 120 to another, thereby reducing the existing resistance levels between the electrodes 120.

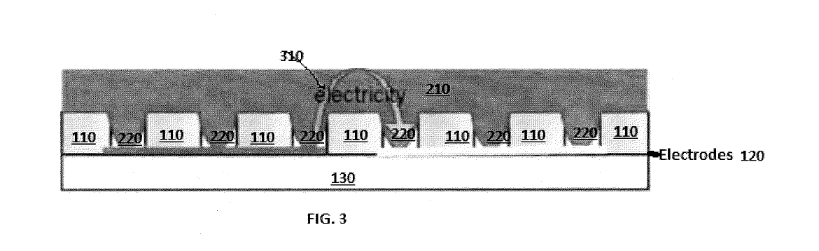

FIG. 3 is a side view of the chemical sensor 100 after detection of target molecules. As described above, the geometrical configuration of the structures 110 (positioned on substrate 130) and the chemical properties of the material used for the structures 110 are selected to ensure that the conductive liquid 210 flows into the gaps 220 at a certain threshold concentration of a target analyte. The threshold concentration of the target analyte may be tuned to the desired application. Specifically, the value of the threshold may be determined using certain characteristics of the materials that can be converted from being hydrophobic materials into being hydrophilic materials (or at least into having reduced hydrophobicity levels) materials in response to exposure to a target analyte. To determine the threshold, for example, certain embodiments may employ characteristics such as functional groups on the surface of the hydrophobic materials to alter its hydrophobicity.

The sensor 100 is switched “ON” as an electrical current 310 passes from one electrode 120 to the other through the conductive liquid 210. The sensor may include an optional display or any other indicator known in the art that displays its “ON” or detection state.

In some embodiments, a conductive metal (e.g., chromium or aluminum) may be deposited for the electrodes 120 before the micro/nanostructures 110 are built. At the initial state, the conductive electrodes 120 under the micro/nanostructures 110 are electrically disconnected since the hydrophobic micro/nanostructures 110 maintain an air gap 220 between the conductive liquid 210 (e.g., water) and the electrodes. This state gives an “OFF” signal which is maintained until any change is made in the surface energy of the material (shown in FIG. 2).

The material for the micro/nanostructures 110 is designed either to react with a certain chemical or organic species or adsorb the target compounds. Once reacted/absorbed, the surface energy of the material increases and the contact angle between the material and conductive liquid 210 decreases. This results in a change in the contact angle without any change in dimensions. At a specific extent of reaction, or when a specific surface coverage is reached due to the adsorption of the target compound, the contact angle decreases enough to allow the permeation of the conductive liquid 210 into the micro/nanostructures 110. Consequently, the conducting liquid medium 210 flows into the gap, electrically connecting the electrodes and switching the sensor “ON.”

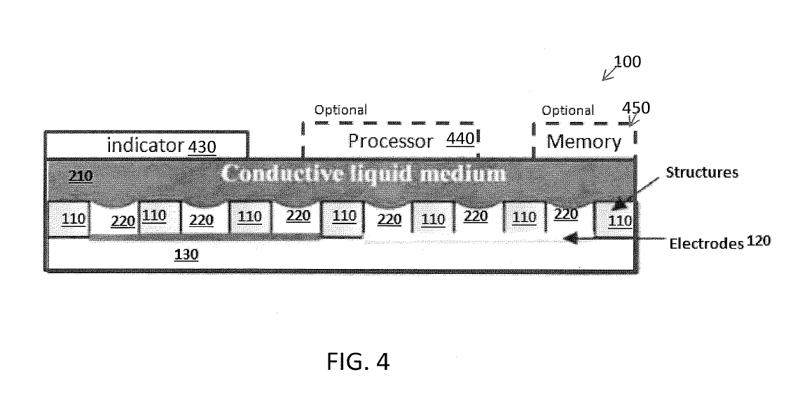

FIG. 4 is an illustration of an example embodiment of the present invention. As shown in FIG. 4, a sensor 100 includes a substrate 130 and a plurality of hydrophobic structures 110 that are distributed spatially on conductive electrodes 120. The plurality of hydrophobic structures 110 are separated by short gaps 220 (e.g., air gaps). The plurality of hydrophobic structures 110 may be of any shape and/or size and be arranged in an array of symmetric or non-symmetric structures.

The structures 110 have a hydrophobicity that varies in response to exposure to a target analyte while submerged in a conductive liquid medium 210. The conductive medium is may be water or any other conductive liquid medium known in the art including, but not limited to, blood.

The hydrophobicity of the structures may decrease in response to exposure to the target analyte, thereby allowing permeation of the conductive liquid on to the conductive electrodes. The permeation of the conductive liquid on to the conductive electrodes results in reduction of the resistance between at least two of the conductive electrodes 120.

The sensor 100 further includes an indicator 430 that indicates detection of the target analyte in response to detection of a change in resistance between the conductive electrodes 120. The indicator 430 may be a display that signals off and on states of the sensor. In some embodiments, the indicator may be embedded into the sensor or directly connected to the sensor.

The indicator 430 may be any known means in the art for signaling/indicating presence of a target analyte in the conductive liquid medium. In some embodiments, the indicator 430 may be a change of color (e.g., change of the color of the liquid medium).

In some embodiments, the indicator may be coupled to an optional processor 440 that measures the resistance between the electrodes, records the observed resistance between the electrodes, and/or calculate the difference between observed resistance readings. In some embodiments, the processor 440 may compare the observed resistance reading(s) against a predetermined/preprogrammed threshold in order to indicate presence of a target analyte in a conductive fluid medium 210.

In some embodiments, the sensor may include a memory 450, coupled with the processor that stores information such as observed resistance values and threshold values.

In some embodiments, a resistance-based output monitoring technique may be suitable for detecting the target analyte. Specifically, a change in resistance between two of the electrodes 120 may be used to indicate detection of the target chemical. Further, in certain embodiments, highly sensitive detection may be achieved by distributing a large number of the structures over a wide area. For example, in some embodiments, the sensitivity of a sensor may be increased if the height, h, of the structure is smaller than the distance, d, between the structures. In such embodiments, the sensor can react to smaller changes in hydrophobicity of the structures and detect smaller concentration of the target analyte. Similarly, a sensor having structures whose height, h, is much larger than the distance, d, between the structures, may require a higher concentration of target analyte for accurate detection.

In certain embodiments, the plurality of structures may be of various heights, sizes, and/or geometric structures. Certain embodiments may include a plurality of zones where the structures in the zone are the same but each zone is different in sensitivity. In some embodiments, the geometrical dimensions of the sensor may impact robustness of the sensor. For example, in certain embodiments, a robust sensor is preferably one that has short structures (i.e., less than 1 micrometer) in height. In another embodiment, a suitable sensor may have structures preferably in the tens of micrometer range.

Most existing chemical sensors constantly consume electricity when they are in operation. In contrast, with embodiments of the present invention, power is not consumed unless the sensor is exposed to the analyte. Further, in order to minimize power consumption, certain embodiments may employ a disposable (i.e., one-time use) sensor. The sensor may work as a passive “OFF”-to-“ON” electrical switch. Further, the sensor may have a low power consumption design that provides “ON” and “OFF” signals as its readout.

The detection limit and robustness of the sensors depend on the material and dimensions of used in making the micro/nanostructures. The detection limit and robustness of the sensors may be tuned and controlled. This enables the sensor design to be used in a wide range of applications.

Further, embodiments of the present invention do not require any complex electric circuits for the processing of output signals. The sensor 100 may include simple micro/nanostructures 110 and electrodes 120. Both components 110, 120 may be readily fabricated by using conventional micro fabrication processes. The micro/nanostructures 110 may also be formed using non-conventional lithography techniques, such as capillary lithography, or by coating pre-formed micro/nanostructure 110 components, such as track-etched or anodized alumina membranes.

Due to their comparatively simple and low cost manufacturing processes and their micro or nanoscale dimensions, embodiments of the present invention may be used to detect a wide range of target chemicals in conductive liquid media.

Further, sensors developed according to embodiments of the present invention may be used to complement existing sensors in the art, thereby increasing the probability of detection while reducing false positives.

While this invention has been particularly shown and described with references to example embodiments thereof, it will be understood by those skilled in the art that various changes in form and details may be made therein without departing from the scope of the invention encompassed by the appended claims.

References, the teachings of which are incorporated herein by reference.
[1] Y. Jeffrey Yang et al., “Adaptive monitoring to enhance water sensor capabilities for chemical and biological, contaminant detection in drinking water systems,” Proc. of SPIE Vol. 6203.
[2] J. de Sanoit et al., “Electrochemical diamond sensors for TNT detection in water,” Electrochimica Acta 54 (2009) 5688-5693.
[3] Ana Pereira et al., “Using Nanovibrations to Monitor Biofouling,” Biotechnology and Bioengineering, Vol. 99, No. 6, 1407-1415.
[4] Wadkins R. M et al., “Detection of multiple toxic agents using a planar array immunosensor,” Biosensors and Bioelectronics, v. 13, n03, pp. 407-415(9), 1998.
[5] Anderson, G. P. et al., “Raptor: A portable, automated biosensor,” Proc. the 1^{st} Conference on Point Detection for Chemical and Biological Defense. 2000.
[6] K. Masunaga et al., Sens. Actuators B 108 (2005) 427.
[7] Ogert, R. A. et al., “Toxin detection using a fiber-optic-based biosensor,” Proc. SPIE Vol. 1885, p. 11-17.
[8] A. Hilmi et al., J. Chromatogr. A 844 (1999) 97.
[9) E. Erc, ag, A. Uzer, R. Apak, Talanta 78 (2009) 772.
[10] I. R. Lewis et al., Spectrochim. Acta 51 (1995) 1985.
[11] Anish Tuteja, et al., “Designing Superoleophobic Surfaces,” Science 318, 1618 (2007)
[12] Sun Taolei, et al., “Reversible switching between superhydrophilicity and superhydrophobicity,” Angewandte Chemie International Edition, Vol. 43, Issue 3, pages 357-360, Jan. 5, 2004.

1. A sensor, comprising:
a plurality of hydrophobic structures spatially distributed on conductive electrodes, the plurality of hydrophobic structures being separated by short gaps and having a hydrophobicity that varies in response to exposure to a target analyte while submerged in a conductive liquid medium; and
an indicator that indicates detection of the target analyte in response to detection of a change in resistance between at least two of the conductive electrodes.

2. The sensor of claim 1 wherein the conductive liquid medium is water.

3. The sensor of claim 1 wherein the hydrophobic structures are at least one of microstructures or nanostructures.

4. The sensor of claim 1 wherein the conductive electrodes are electrically disconnected from one another.

5. The sensor of claim 1 wherein the plurality of hydrophobic structures are arranged in an array of symmetric or non-symmetric structures.

6. The sensor of claim 1 wherein the hydrophobic structures, upon being submerged in the conductive liquid medium, create high contact angles with the conductive liquid that result in forming air gaps between the conductive electrodes and surrounding conductive liquid.

7. The sensor of claim 6 wherein the air gaps cause an initial high resistance between the conductive electrodes.

8. The sensor of claim 1 further including a display that signals off and on states of the sensor.

9. The sensor of claim 1 wherein the hydrophobicity of the structures decreases in response to exposure to the target analyte.

10. The sensor of claim 9 wherein exposure to the target analyte includes at least one of reaction to the target analyte or absorption of the target analyte.

11. The sensor of claim 1 wherein the hydrophobicity of the structures decreases in response to exposure to the target analyte thereby allowing permeation of the conductive liquid on to the conductive electrodes.

12. The sensor of claim 11 wherein permeation of the conductive liquid on to the conductive electrodes results in reduction of the resistance between at least two of the conductive electrodes.

13. A method for sensing a target analyte, comprising:
submerging a sensor including a plurality of hydrophobic structures spatially distributed on conductive electrodes in a conductive liquid medium, the plurality of hydrophobic structures being separated by short gaps and having a hydrophobicity that varies in response to exposure to a target analyte; and
indicating detection of the target analyte in response to detection of a change in resistance between at least two of the conductive electrodes.

14. The method of claim 13 wherein the conductive liquid medium is water.

15. The method of claim 13 wherein the hydrophobic structures are at least one of microstructures or nanostructures.

16. The method of claim 13 wherein the conductive electrodes are electrically disconnected from one another.

17. The method of claim 13 further including arranging the plurality of hydrophobic structures in an array of symmetric or non-symmetric structures.

18. The method of claim 13 further including forming air gaps between the conductive electrodes and surrounding conductive liquid by submerging the hydrophobic structures in the conductive liquid medium to create high contact angles with the conductive liquid.

19. The sensor of claim 18 wherein causing an initial high resistance between the conductive electrodes using the air gaps.

20. The method of claim 13 further including signaling off and on states of the sensor.

21. The method of claim 13 wherein the hydrophobicity of the structures decreases in response to exposure to the target analyte.

22. The method of claim 21 wherein exposure to the target analyte includes at least one of reaction to the target analyte or absorption of the target analyte.

23. The method of claim 13 further including decreasing hydrophobicity of the structures by exposing the structures to the target analyte and allowing permeation of the conductive liquid on to the conductive electrodes.

24. The method of claim 23 further including reducing the resistance between at least two of the conductive electrodes as a function of permeation of the conductive liquid on to the conductive electrodes.
